(19) United States
(12) Patent Application Publication
(10) Pub. No.: US 2003/0036468 A1
(43) Pub. Date: Feb. 20, 2003

(54) Device and method for automatic processing of sheet-shaped print materials with interchangeable functions

(76) Inventors: Kurt Blank, Ebersbach (DE); Eduard Muller, Geislingen-Turkheim (DE); Jurgem Ries, Ostfildern (DE)

Correspondence Address: Kevin Leffel, Heidelberg Digital L.L.C., 2600 Manitou Road, Rochester, NY, 14624, US

(21) Appl. No.: 10/207,535

(22) Filed: Jul. 29, 2002

(30) Foreign Application Priority Data
Jul. 30, 2001 (DE) 101 37 165.9
Mar. 1, 2002 (DE) 102 09 090.4

(51) Int. Cl. B26D 1/14

(52) U.S. Cl. 493/8; 493/362; 83/481

(57) ABSTRACT

The invention relates to a device and method for processing of sheet-shaped materials comprising a first module having a first sheet-processing mode, a second module having a second sheet-processing mode, the first module being interchangeable with the second module within a common space. The sheet-processing modes include, without limitation, punching, cutting, embossing, creasing, folding and perforating, without limitation, alone or in combination. The first and second modules may be interchanged manually or automatically.

### BACKGROUND

The invention is in the field of automatic processing devices for sheets, for example cutting, embossing, punching, folding.

In the printing industry, there is a need for mechanical processing of print materials, especially in further print processing for preparation for a binding process by means of which individual printed sheets are combined into a brochure, a book or the like.

Among the many possible further processing options that are detailed, e.g. in H. Kipphan: “Handbook of Print Media”; Springer Verlag (2000), on-the-fly processing of sheet-shaped materials is described. On-the-fly processing is understood to mean that the sheet-shaped materials are processed while moving, in contrast to systems in which several sheet-shaped materials are punched or cut in a resting state. Typically in on-the-fly processing, the sheet-shaped materials are processed individually and then collected, as opposed to other methods where the sheet-shaped materials are first collected and then processed. On-the-fly processing of sheet-shaped materials has an advantage over this in that the processing better corresponds to the work sequence of a printing machine for sheet-shaped materials that typically prints the sheet-shaped materials sequentially. Therefore, on-the-fly processing for print further processing is especially suited for so-called in-line devices that are connected directly to such printing machines, e.g. a digital printer or copier. In this case, the on-the-fly processing is not bound to in-line devices but can also be advantageously used in offline devices that are not in direct contact with a printing machine.

The further processing options or processing modes involve, for example, punching holes in the print materials, e.g. for binding or for ring bindings or for subsequent wire/plastic bindings, the cutting of the print materials, e.g. for format reductions or tabs, the embossing of inscriptions or emblems, e.g. for letterheads or book covers, or a perforation of pages, e.g. for pocket calendars, the folding of sheet-shaped materials and creasing of print materials to support folding procedures, especially for book covers.

Devices that carry out these various further processing options or processing modes are known in great numbers from the state of the art and are also explained clearly by H. Kipphan.

It is desirable to keep a further processing device as flexible as possible since the requirements e.g. of the position of holes or perforations can change from one print order to the next. Therefore, it is desirable to make available further processing devices with which a change between different processing modes can be carried out quickly with a large number of different processing modes.

In web presses, punching plates are used that bear raised structures that are produced by means of micro-mechanical surface systems. For print further processing, the punching plates are drawn on magnetic rollers across from opposing cylinders and print media passing through are perforated, punched, creased or cut by the raised structures. In this process, magnetic roller and opposing cylinder move synchronously with the preceding printing units. The disadvantages of this process are the high purchase costs and the individual costs for production of the punching plates, so this technology is only suitable for large press runs.

U.S. Pat. No. 2,116,391 discloses a device for flexible adjustment of punching patterns in a punching device. Here individual punches are fixed on ring gears that can be moved axially. Because of the ring gears, which are also equipped with a scale, a correct angular positioning of the punch on the circumference of the ring gear is achieved, the same is true for the positioning of the associated dies. In the solution suggested in the above-mentioned document, the punches are bolted individually into their planned position. Because of this, a flexible change is in fact possible but involves considerable time.

U.S. Pat. No. 5,669,277 suggests a rotary hole-punching device in which, in a first shaft, brackets are provided for punches for a number of different hole combinations. The change between different hole patterns is carried out by installing or removing the respective punch from the corresponding brackets. Consequently, a high precision is achieved in the punching positions. On the other hand, the disadvantage is that the punches have to be changed manually for each change of the punching pattern.

A device is disclosed in the DE 34 27 686 A1 in which a hole-punching device on a punch ring has a number of punches mounted on it radially at specific distances from each other that can be shifted radially by means of internal cam rings between a first outer punching position and a withdrawn passive position. In addition, the punch rings can be shifted on the shaft along the axis so that a large number of different punching patterns can be created. The disadvantage of the solution described is that the change between the punching patterns is not possible when operation is running.

International Application WO 98/55278 suggests a process for changing perforation patterns in which perforation tools are also radially brought from a passive to an active position and in this way lead to a change in the perforation pattern. To do this, the perforation tools are mounted against a hose with spring pressure whereby the hose winds around the roller as a helix or double helix inside the roller that holds the tool. If the hose is inflated, this causes a lifting of the tools into their active position. The advantage of this design is that a change between the punching patterns is possible here at any time. On the other hand, the disadvantage is the limited number of different patterns; these depend on the number of hoses that wind around the roller holding the tool, since an entire hose is always inflated.

DE 28 11 109 discloses a modular structure of a horizontal perforation device in which perforation procedures are divided, i.e. carried out by separate rollers and whereby the distribution of the horizontal perforation can be controlled by changing the relative position of the rollers with respect to each other. Depending on the number of separate perforation rollers, different perforation patterns can be achieved in this way. The disadvantage is that a large number of movable parts is required.

EP 1029640A2 discloses a horizontal processing device that has two processing units that follow each other in succession and because of this represent two successive processing levels, whereby each of the processing units can be selected by a control. In one embodiment, the horizontal processing device is made up of a first synchronous cutter and an immediately adjacent dynamic variable cross cutter. According to the disclosure, in each case one of the cross cutters can be stopped as long as the other one is working. In this case, the individual cutter that has been stopped forms a pass-through into which the guide table can be introduced. Because of the optional use of two cross cutters, a larger number of different formats can be cut.

In the further processing of print products, typically a large number of different processing modes are used; however, frequently only one change in a punching or perforation pattern is not enough, rather the print materials also have to be cut, embossed and/or creased. The disadvantage in the named devices and comparable devices of the state of the art is that only one processing mode, i.e. stamping or punching or creasing or embossing, etc., is possible.

However, a device would be desirable with which a number of processing modes is possible, which advantageously has additional different functions, e.g. 2-hole or 4-hole punches, and a change between the processing modes can be carried out quickly and easily and that is also suitable for small press runs, say in combination with digital printing.

### SUMMARY OF THE INVENTION

According to one aspect of the invention, a device and method for processing sheet-shaped materials wherein a first module having a first automatic sheet-processing mode is placed in a space. A second module having a second automatic sheet-processing mode may be interchanged with said first module within the space.

### BRIEF DESCRIPTION OF THE DRAWINGS

FIG. 1 presents schematic top view of one embodiment of a device according to the invention.

FIG. 2 presents a schematic side view of the FIG. 1 device.

FIG. 3a presents a schematic perspective view of a preferred embodiment with several holding locations.

FIG. 3b presents a schematic perspective view of a preferred embodiment with automatic changer for processing modules.

FIG. 4 presents a schematic view of one embodiment of a processing module according to one aspect of the invention.

FIG. 5 presents a schematic representation of an example embodiment of a tool roller for a punching module.

FIG. 6a presents a schematic representation of an example embodiment of a tool roller for a cutting module.

FIG. 6b presents a schematic representation of an example embodiment of a tool roller for a cutting module for edge cutting for register sheets.

FIG. 7 presents a schematic representation of an example embodiment of a tool roller for an embossing module.

FIG. 8 presents a schematic representation of an example embodiment of a tool roller for a perforating module.

### DETAILED DESCRIPTION

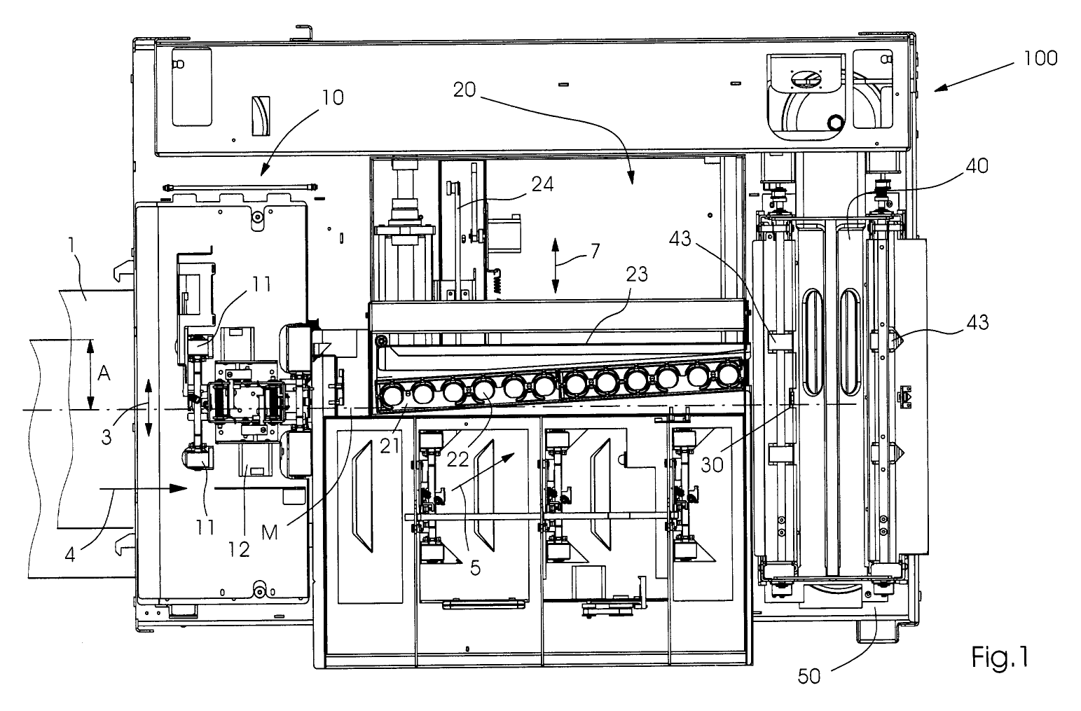

Various aspects of the invention are presented with reference to FIGS. 1 through 8, which are not to any particular scale, and wherein like components in the numerous views are numbered alike. In general, the drawings are schematic in nature, with details such as suitable drive and/or guide means, cams, electrical circuits, etc., being apparent from the description provided herein.

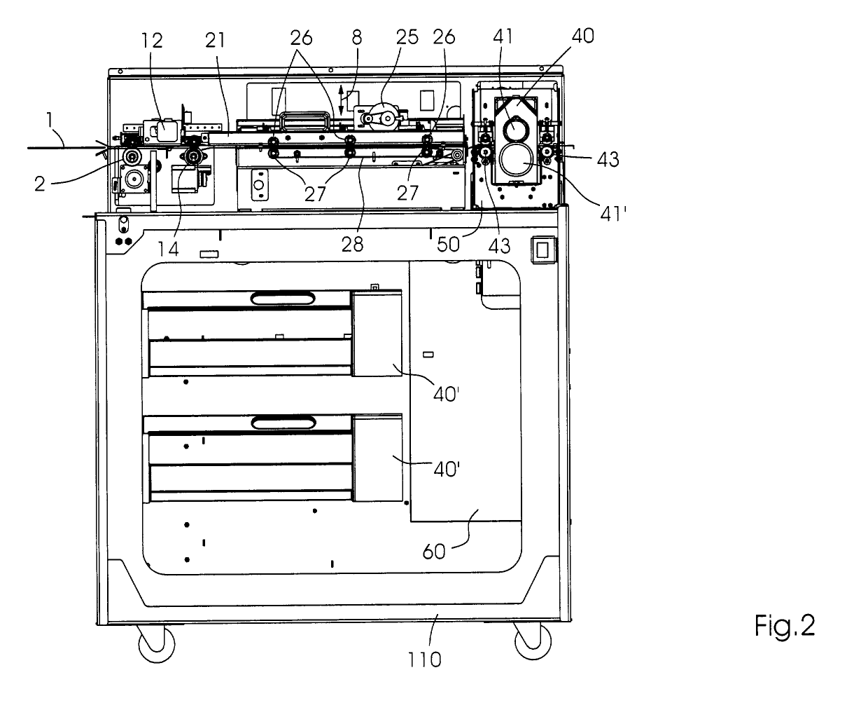

Referring now specifically to FIGS. 1 and 2, a device 100 having automatic paper processing equipment of a type that processes sheet-shaped print materials, is presented. Sheet-shaped materials 1 enter in the area of a transport roller pair 2 and have a distance A from the lateral edge of the sheet-shaped print material 1 to the center line M of the transport path of the sheet-shaped materials 1 through the device 100 along the movement direction indicated with reference number 4. In a pre-register 10, the distance A is determined by means of an edge sensor (not shown), and transferred using a logic, as is well known in the art. Axially displaceable transport rollers 11 are oriented during the passage of the sheet-shaped print material 1 to the sheet-shaped print material 1 such that the distance A essentially corresponds to half the width of the sheet-shaped print material 1. The pre-register can be compensated so that deviations from the center of the sheet-shaped print material 1 from the center line M of ±15 mm can be compensated before pre-register 10 and the sheet-shaped print material 1 can be transferred with a precision of +4 mm to the subsequent register 20. This procedure is monitored during the movement by the edge sensor, which indicates when the sheet-shaped print material 1 reaches a specified position over center line M. To do this, the edge sensor can be moved perpendicular to the center line in order to adjust its position to the format of the sheet-shaped print material 1 currently being processed. The movement in the direction indicated with reference number 3 in FIG. 1 of the sheet-shaped print material 1 in the area of the pre-register 10 is made possible by a motor 12 that is in working connection with the axially movable transport roller pair 11.

The sheet-shaped print material 1 is transferred downstream to a register 20. In the area of the register 20, the sheet-shaped print material 1 is guided by means of a slanted transport belt 28 into the direction indicated with reference number 5 against a stop 23. In addition, the sheet-shaped print material 1 is moved in the movement direction 4 along the center line M of the transport path. The slanted movement is made possible by a roller conveyor that presses the sheet-shaped print material 1 against the slanted transport belt. Because of the sliding of the sheet-shaped print material 1 against the stop 23, any positional inaccuracy of the sheet-shaped print material 1 is compensated with adequate precision for the following processing procedure, i.e. the lateral edges of the sheet-shaped print material 1 are parallel to the center line M. The distance of the stop 23 from center line M is automatically adjustable by means of a pulley 24 in order to adjust the distance to the format of the sheet-shaped print material 1. Instead of the pulley, a cam or another mechanism from the state of the art known to the person skilled in the art can be used for controlled movement. With device 100, in this way, sheet sizes from 140 mm to 300 mm width can be continuously adjusted to center line M.

The register 20 may be bypassed. For example, a cam 25 (see FIG. 2) or other suitable drive, raises the roller conveyor 21 in the direction indicated with reference number 8 in FIG. 2 and at the same time a transport roller pair 26 is brought into contact with the sheet-shaped print material 1. Because of the lifting of the roller conveyor 21, the function of the slanted belt conveyor 28 is switched off and a change in the position of the sheet-shaped print material 1 in relationship to the center line is precluded.

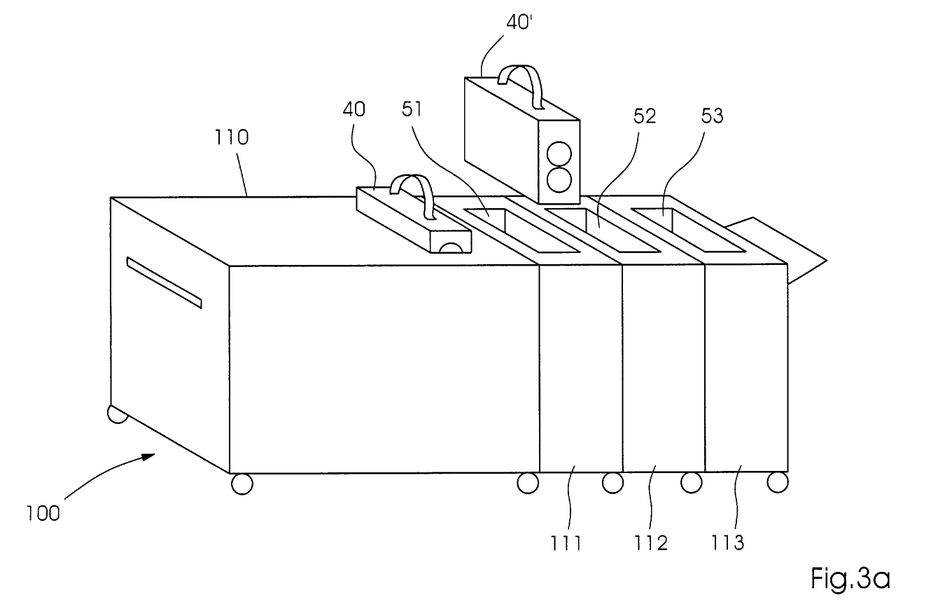

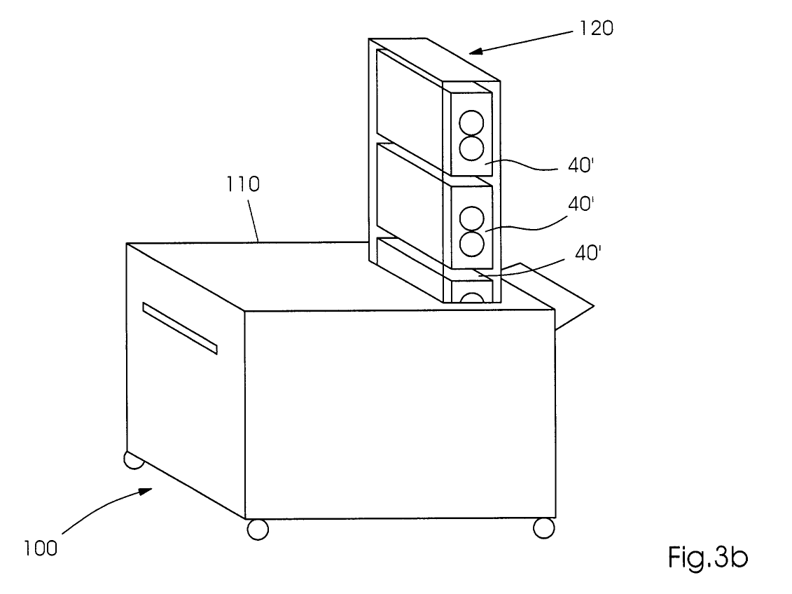

The sheet-shaped print material 1 is carried on to the processing module 40 and there processed according to the functionality of the processing module 40. Alternatively, the sheet-shaped print material 1 may be further transported to another processing module 40′ as can be seen in FIG. 3a. The sheet-shaped material 1 may also be transported to a storage bin (not shown) for sheet-shaped materials. The sheet-shaped material 1 may also be transported to another independent processing module, e.g. a binding device. The operations may be combined with one or more other operations, and the possibilities are too numerous to list here, such variations being evident from the description provided herein. The processing module 40 may be mounted in a holding location 50, 51, 52, 53 so that it can be removed, as is shown in FIGS. 2 and 3.

In a bypass operation, the signal of the edge sensor 30 may be ignored and the sheet-shaped print material 1 may be transported only from the transport rollers 43 through the processing module 40 without any processing being initiated by processing tool 41.

A waste container 60 that may be easy to empty or replace is preferably placed below the processing module 40.

As shown in FIG. 3a, the device 100 has a modular structure. Processing modules 40 with specific processing modes are installed in holding locations 51, 52, 53 provided for them and fastened there so that they can be removed, e.g. by clamping or by bolting or by a comparable mechanism. According to one aspect of the invention, any desired number of holding locations may be provided. In a variation shown in FIG. 3a, the device 100 has a housing 110 with a holding location for a processing module 40 in a holding location 50, additional processing modules 41′ can be installed in additional housings 111, 112, 113, whereby the attachment of the additional housing functions according to the “plug and play” principle. For example, a first module is interchangeable with a second module within a common space in the housing 110. Because of this, depending on the requirement, the size of the device 100 according to the invention can be adjusted to different requirements, say the requirements of a printing or print further processing operation.

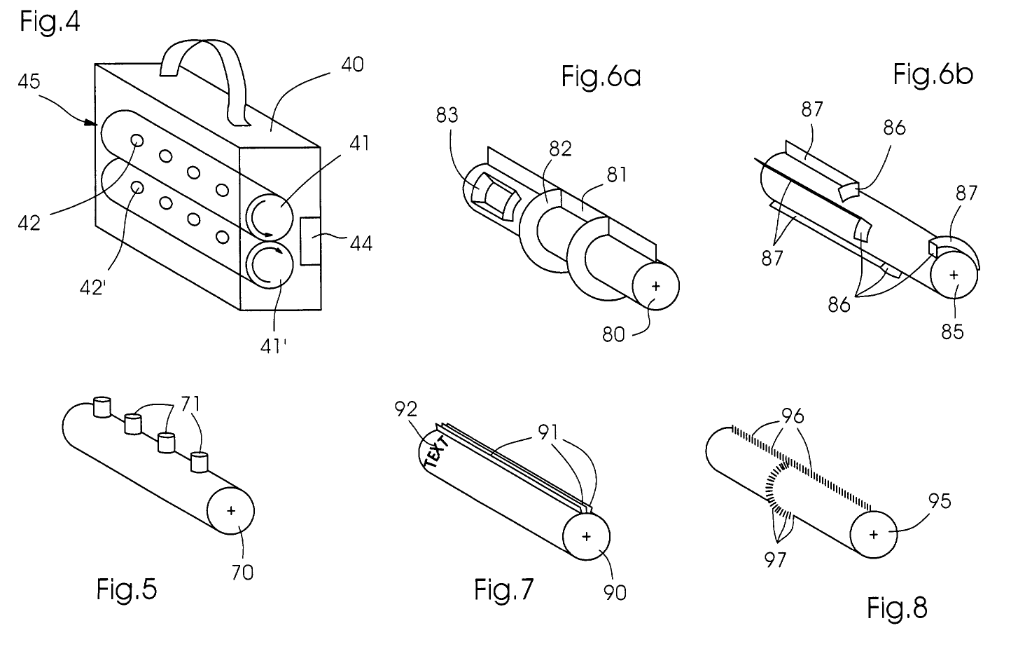

For device 100, a large number of different processing modules 40 with different processing tools 70, 80, 85, 90, 95 are available, as presented in FIGS. 4 through 8. The processing tools 70, 80, 85, 90, 95 may carry out at least one processing mode or, as described in more detail below, in some cases a larger number of different processing modes may be carried out.

According to a further aspect of the invention, a change between different processing modes may be carried-out automatically. Of course, a change between different processing modes may be carried out manually.

Referring again to FIG. 3a, the replacement of a first and a second processing module 40, 40′ is carried-out by loosening a detachable fastener between the first processing module and the holding location 50, 51, 52, 53, removing the first processing module 40, installing the second processing module 40′ in the holding location 50, 51, 52, 53 that is now available and closing the detachable fastener between processing module 40 and the holding location 50, 51, 52, 53. Mechanical and/or electrical interfaces 44 may be provided to come in contact with the processing module and the associated holding location 50, 51, 52, 53, which ensure drive for the movements within the processing module 40, 40′ and/or the transfer of electrical control signals, for example initiating a processing procedure.

If several holding locations 50, 51, 52, 53 are present, a change in the processing modes of processing modules 40, 40′ already installed in the holding locations 50, 51, 52, 53 can also be carried out in that the processing module 40 with the first processing mode is switched from active operation to bypass operation and a second processing module 40′ that until then e.g. was in bypass operation, is switched into active operation. This switching can be controlled either manually or automatically.

Other combinations of changes between processing modes that result from the change of processing modules 40, 40′ with different processing modes, the change of different processing modes of individual processing modules 40, 40′ and the use of a number of holding locations 50, 51, 52, 53 for these processing modules also lie in the scope of the invention explained here.

Referring now to FIG. 3b, another embodiment of device 100 is presented wherein a number of processing modules 40, 40′ may be arranged above each other in a processing module changer 120. The change between the processing modules 40, 40′ is carried out here by a vertical movement of the processing modules 40, 40′, after which the fastening of the current processing module 40 in holding location 50 is automatically triggered. As soon as the new processing module 40′ is installed in holding location 50, the fastening of the processing module 40′ is completed and the device is configured for the new processing module 40′. A revolver-shaped arrangement of the number of processing modules may also be implemented. A mixture of manual and automatically changeable processing modules is also within the scope of the disclosure explained here.

The structure of a processing module 40 is shown schematically in FIG. 4. According to the embodiment shown in FIG. 4, the processing module 40 is equipped with a two-part rotary processing tool 45. For this, within the processing module 40, two cylindrical opposing rollers 41, 41′ are mounted, a tool roller 41 and a die roller 41′, which carry out synchronized movements, e.g. by a coupling using a gear or a toothed or V belt or other coupling mechanism known to the person skilled in the art. The upper processing tool 41 holds tool elements 42.

The possibilities are numerous. Some examples are presented in FIGS. 5 through 8. The tool roller 70 of FIG. 5 is configured for punching holes in sheet-shaped materials 1, e.g. for storage in binders or for preparing for a subsequent wire comb binding. Here punching elements 71 are located radially around the circumference of the punching tool 70. In this process, it is possible to change between different punching patterns by radially lowering the punches below the circumference of the punching tool 70.

Referring now to FIG. 6a a tool roller 80. In this process, radially around the circumference of the cutting tool 80 there are transverse cutting elements 81 and/or longitudinal cutting elements 82, e.g. for format reduction or edge trimming and/or cutting elements 83 for producing windows or other shapes in a sheet-shaped print material, as they are often placed in the covers of so-called soft cover books.

Referring now to FIG. 6b a tool roller 85 is presented for producing edge trimming for tabs. In this case, one of the cutters 87 is aligned essentially parallel to the page edge into which the tab will be brought. At least one second cutter 86 cuts perpendicular to this and carries out a complete separation of superfluous material. Also, cutters having corresponding geometries are possible for a semi-circular cut for tabs, or other shapes.

Referring now to FIG. 7 a tool roller 90 is presented for embossing. In this process, embossing grooves 91 are found radially around the circumference of tool roller 90 which can run e.g. axially or in circumference direction and/or upper dies for embossing inscriptions 92 or emblems, logos or other things.

Referring now to FIG. 8 a tool roller 95 for perforating is presented comprising an axial array of perforating needles 96 and/or a circumferential array of perforating needles 97 for corresponding production of tearaway edges in a sheet-shaped print material.

In the examples presented, the tool elements 42, 71, 82, 83, 86, 87, 91, 92, 96, 97 extend beyond the circumference of the tool roller and during rotary movement of the upper processing tool extend into the plane in which the sheet-shaped materials 1 are moving, whereby the processing of the sheet-shaped materials is achieved. The lower processing tool has dies 42′ that correspond to the respective tool elements 42, 71, 82, 83, 86, 87, 91, 92, 96, 97 of the upper processing tool 41 and are engaged with these tool elements 42, 71, 82, 83, 86, 87, 91, 92, 96, 97 for processing a sheet-shaped print material that is passing through while the rollers 41, 41′ are rotating. Because of the fact that the die roller 41′ is in continuous active connection with the tool roller 41, being replaced together with the tool roller 41 when processing modules 40, 40′ are changed, a time-consuming adjustment between the two rollers 41, 41′ is eliminated, which would otherwise have to occur at each change.

The device described is used especially in in-line further processing of print products of digital printing machines. Use in all copiers/printers in which sheet-shaped print materials are subsequently processed is also possible, especially including use in off-line further processing. Numerous variations and modifications of the invention are evident in light of the description provided herein.

The device may have a modular structure. The device comprises at least one two-part processing tool with at least one specific processing mode whereby the entire operating tool is mounted within a processing module and the device has at least one holding location for a processing module so the processing module can be replaced in a simple way with another processing module. However, according to the invention, the device is not restricted to one holding location for a processing module, but much more so can have a number of holding locations into which a corresponding number of processing modules can be installed and also can be replaced, whereby the processing modules optionally can differ as to functionality but do not have to differ.

The processing mode may be at least one of the processing modes of punching, cutting, embossing, creasing, folding or perforating. As a result, with device by installing the processing module involved each of the specified processing modes can be carried out, and a change between the processing modes with a replacement of processing modules involved is carried out quickly, easily and cost-effectively, comparable to “plug and play”.

The device may have at least one register device downstream before the processing module for aligning the sheet-shaped materials when they are running into the device.

The register device may align a sheet-shaped print material transported on a pass-through path, centrally to the pass-through path, by means of a slant run, especially according to the format of the sheet-shaped print material. During further processing, it is effective to align the position of the sheet-shaped print material centrally in the transport path since the processing modes frequently take place symmetrically to the center line of a sheet-shaped print material, especially when punching holes in sheets. The central alignment advantageously is carried out by a movement that runs at a slant to the transport direction and guides one edge of the sheet-shaped print material against a stop, whereby the stop optionally automatically assumes a distance relative to the center line of the transport path depending on the format of the sheet-shaped print material that is passing through, which corresponds to half the width of the sheet-shaped print material.

The device may have at least one sensor device upstream from the processing module to control the processing procedure. The sensor device may detect the front edge of a sheet-shaped print material passing through and because of this triggers a processing procedure. Typically, a light curtain is used here which can recognize the presence of either a transparent or an opaque material edge with the required precision. Light curtains of this type are known from the state of the art. In an advantageous further development of the embodiment, this signal of the sensor is used in order to initiate a processing procedure of the processing module either immediately or with a delay. Because of this, it is possible to locate the processing, for example hole punching, perforating or cutting at any place on the sheet-shaped print material.

With a bypass operation for at least one processing module, no processing procedure is triggered, rather a sheet-shaped print material that is running in is transported past the processing module involved. This is advantageous if the device is in connection in-line with a printing machine/copier and the printing machine/copier is also used for print orders that do not require any further processing. In addition, the option of bypass operation is advantageous if the device includes, for example, two processing modules that are used alternately and in each case processing is only carried out on one processing module and the other is in bypass operation. In this way, a change between processing modes is possible without having to replace the processing modules.

The two-part processing tool may be a rotary processing tool in which a tool roller is mounted above the pass-through path of a sheet-shaped print material, whereby the tool roller has at least one tool element that extends beyond the circumference of the first tool roller and a die roller is mounted below the pass-through path whereby the die roller has at least all the dies corresponding to the tool elements of the tool roller and the two rollers are arranged in a processing module in such a way and are in active connection with each other so that when the rollers turn around their axles in opposite directions, the tool element of the tool roller comes into engagement with the corresponding dies on the die roller.

The processing module may be a punching module, whereby the tool elements represent punches which are arranged in at least one possible hole combination on the tool roller to put holes into a sheet-shaped print material that is passing through. In this process, the hole combination can represent, in particular, a row of holes that is put in along the edge of the sheet-shaped print material in order to then be able to carry out a wire binding.

The punching module may be designed in such a way that the punching module can change between different hole combinations, in which the position of a few of the punches that are located on the circumference of the tool roller can be changed radially, in particular these punches can be lowered and thus not contribute to producing holes in the sheet-shaped print material. Waste that occurs during punching with the punching module may be transported through the inside of the die roller to the outside, where it can then fall into a waste container that is easy to empty.

At least one processing module may be a cutting module in which the tool elements represent cutters that are mounted in circumference direction and/or parallel to the axis and/or in any other alignment on the circumference of the tool roller in order to cut sheet-shaped materials. In this process, a format reduction of the sheet-shaped print material can advantageously be carried out using the cutting module, in particular a reduction from A3 to A4 and/or from A4 to A5. This is especially advantageous since the printing of smaller formats like A5 causes great technical difficulties and standard printers, printing machines and many further processing devices are not designed for these formats.

The cutter may be configured in such a way that sheet-shaped materials passing through them can be provided with a tab edge cut. Tabs are used in order to permit faster opening of a book or a newspaper. In this process, the tab markings produce notches in the lateral edge that are created by a corresponding cut.

At least one of the processing modules may be an embossing module with which sheet-shaped materials are embossed by means of stamps applied on the circumference, especially provided with an inscription. The tool elements may be blunt blades that are mounted parallel to the axis and/or in circumference direction on the circumference of the tool roller on the embossing module by means of which the sheet-shaped materials are creased, especially in order to support a subsequent folding of the sheet-shaped materials. This is especially advantageous for producing binding elements for brochures, ensuring a reduced spreading of the cover, which is frequently produced of a stiffer print material.

At least one of the processing modules may be a perforating module in which the tool elements on the circumference of the tool roller represent needles mounted for perforation of sheet-shaped materials.

The device may have at least two processing modules, while the processing modules may be any combination of punching modules, cutting modules, embossing modules and/or perforating modules.

The change of the processing modules may be carried out automatically. To do this, two or more processing modules are mounted in a module changer, especially above each other, so that if necessary a processing module that is no longer being used can be replaced by a processing module that is needed by vertical displacement.

Also included in the inventive concept is a method for flexible changing of processing modes during on-the-fly mechanical processing of sheet-shaped materials with the following process steps:

Preparing a device according to the invention according to the preceding description,

Loosening the detachable fastener between at least one holding location and the processing module with at least one processing mode that is mounted in it so that it can be removed,

Manually removing the processing module,

Manually installing another processing module with another processing mode,

Closing the detachable fastener between the holding location and the other processing module.

The following step may be additionally carried out at the end:

Automatic configuration of the device with regard to the new processing module.

The change of the processing modules may be carried out automatically rather than by using manual removal and installation of the new processing module.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

What is claimed is:

1. A device for processing sheet-shaped print materials, comprising:
a housing;
a first module having a first automatic sheet-processing mode; and,
a second module having a second automatic sheet-processing mode, said first module being interchangeable with said second module within a common space in said housing.

2. The device of claim 1, wherein said at least one of said first automatic sheet-processing mode and said second automatic sheet-processing mode is chosen from a group consisting of punching, cutting, embossing, creasing, folding and perforating.

3. The device of claim 1, further comprising at least one register device for aligning the sheet-shaped print materials downstream from said space.

4. The device of claim 3, wherein said register device aligns a sheet-shaped print material transported on a pass-through path by a slanted guide.

5. The device of claim 4, wherein said register device includes a movable stop, and said slanted guide urges said sheet-shaped print material against said stop.

6. The device of claim 1, further comprising at least one sensor device at an upstream location relative to said space and implemented in controlling processing by at least one of said first module and said second module.

7. The device of claim 6, wherein said sensor detects the front edge of a sheet-shaped print material passing through and triggers said processing.

8. The device of claim 7, wherein said sensor triggers said processing with timing chosen from a group consisting of immediately and a delay.

9. The device of claim 1, further comprising a bypass that transports a sheet-shaped print material past said space without processing.

10. The device of claim 1, wherein at least one of said first sheet-processing mode and said second sheet-processing mode comprises sheet format reduction by cutting.

11. The device of claim 1, wherein at least one of said first module and said second module comprises a tool roller having at least one tool element that extends beyond a circumference of said tool roller and a die roller having at least one die complementary to said at least one tool element.

12. The device of claim 11, wherein said at least one tool element comprises a hole-punch.

13. The device of claim 11, wherein said die roller is hollow and allows punching waste to pass through the inside of said die roller.

14. The device of claim 11, wherein said tool element comprises a cutter.

15. The device of claim 14 wherein said cutter us shaped such that a tab is cut into one edge of the sheet-shaped print material.

16. The device of claim 11, wherein said tool element comprises an embossing tool.

17. The device of claim 11, wherein said tool element comprises perforating needles.

18. The device of claim 1, said first module being interchangeable with said second module within an additional common space.

19. The device of claim 1, further comprising an automatic module changer.

20. A method for processing sheet-shaped materials, comprising:
placing a first module having a first automatic sheet-processing mode into a space in a housing; and
interchanging said first module with a second module having a second automatic sheet-processing mode within said space.
